(19) United States
(12) Patent Application Publication
(10) Pub. No.: US 2010/0203402 A1
(43) Pub. Date: Aug. 12, 2010

(54) FUEL CELL SYSTEM AND DRIVING METHOD THEREOF

(75) Inventors: Young-Seung NA, Suwon-si (KR); In-Seob SONG, Suwon-si (KR); Ji-Rae KIM, Suwon-si (KR); Hye-Jung CHO, Suwon-si (KR); Kyoung-Hwan CHOI, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd., Suwon-si (KR)

(21) Appl. No.: 12/631,688

(22) Filed: Dec. 4, 2009

Related U.S. Application Data
(60) Provisional application No. 61/150,690, filed on Feb. 6, 2009.

(51) Int. Cl. H01M 8/00; H01M 2/02

(52) U.S. Cl. 429/415; 429/456

(57) ABSTRACT

A fuel cell system and method for driving the same is disclosed. In one embodiment, the fuel cell system includes i) a fuel supply unit, ii) a fuel cell stack in fluid communication with the fuel supply unit, wherein the fuel cell stack has a fuel inlet and a fuel outlet and iii) a bypass pipe configured to transfer fuel received from the fuel supply unit to a fuel outflow pipe connected to the fuel outlet. In one embodiment, the driving method includes i) receiving fuel from a fuel supply unit, ii) transferring the received fuel to a fuel outflow pipe connected to a fuel outlet of a fuel cell stack and iii) discharging non-reacted fuel from a fuel inlet of the fuel cell stack.

### CROSS-REFERENCE TO RELATED APPLICATION

This application claims priority to and the benefit of Provisional Patent Application No. 61/150,690 filed on Feb. 6, 2009 in the U.S Patent and Trademark Office, the entire contents of which are incorporated herein by reference.

### BACKGROUND OF THE INVENTION

1. Field of the Invention

The present invention relates to a fuel cell system and a method for driving the same, and more particularly, to a fuel cell system that improves a structure of supplying fuel to a fuel cell stack.

2. Description of the Related Art

Fuel cells are devices that electrochemically generate power by using fuel (hydrogen or reformed gas) and oxidant (oxygen or air) and directly convert the fuel (hydrogen or reformed gas) and oxidant (oxygen or air) continuously supplied from the outside into electrical energy by an electrochemical reaction. The hydrogen may be generated by reforming hydrocarbon-based fuel (LNG, LPG, CH3OH, etc.).

As an illustrative example of fuel cells, A direct methanol fuel cell (“DMFC”) is an illustrative example of fuel cells known in the art. The DMFC supplies high-concentration methanol to a fuel cell stack to generate electricity by reaction with the oxygen.

When the DMFC is operated for a long time, impurities are stacked in a fuel passage of the fuel cell stack, such that the passage is blocked.

As such, when the passage is blocked, a relevant cell must be replaced or repaired by disassembling the entire stack.

Further, the inside of the stack is deteriorated when the fuel cell system is operated. This deterioration causes the lifespan of the fuel cell stack to be shortened.

### SUMMARY OF CERTAIN INVENTIVE ASPECTS

One aspect of the present disclosure is a fuel cell system having an advantage of easily solving problems occurring in a stack. Another aspect of the present disclosure is a fuel cell system having another advantage of preventing deterioration of a stack.

In another aspect a fuel cell system is configured to remove impurities in a fuel cell stack so as to prevent deterioration of the stack and improve the lifespan of the fuel cell system.

An exemplary embodiment of the present invention provides a fuel cell system that includes a fuel cell stack that generates electrical energy by an electrochemical reaction of the fuel and oxidant and has a fuel inlet through which fuel is injected and a fuel outlet through which the fuel is discharged, a fuel supply unit that supplies to the fuel to the fuel cell stack, an oxidant supply unit that supplies the oxidant to the fuel cell stack, a fuel inflow pipe installed between the fuel supply unit and the fuel cell stack, a fuel outflow pipe through which non-reacted fuel discharged from the fuel cell stack flows, a supplying bypass pipe that is connected to the fuel inflow pipe and the fuel outflow pipe and transfers the fuel injected into the fuel inflow pipe to the fuel outlet, and a discharging bypass pipe that is connected to the fuel inflow pipe and the fuel outflow pipe and transfers the non-reacted fuel discharged to the fuel inlet to the fuel outflow pipe.

The supplying bypass pipe may be installed in the fuel inflow pipe through a supply valve that is composed of a 3-way valve and the discharging bypass pipe may be installed in the fuel outflow pipe through a discharge valve that is composed of the 3-way valve.

Another embodiment of the present invention provides a fuel cell system that includes a fuel cell stack that generates electrical energy by an electrochemical reaction of the fuel and oxidant and has a fuel inlet through which fuel is injected and a fuel outlet through which the fuel is discharged, a fuel supply unit that supplies to the fuel to the fuel cell stack, an oxidant supply unit that supplies the oxidant to the fuel cell stack, a fuel inflow pipe installed between the fuel supply unit and the fuel cell stack, a fuel outflow pipe through which non-reacted fuel discharged from the fuel cell stack flows, a supplying bypass pipe that is connected with the fuel inflow pipe and the fuel outflow pipe through a 3-way valve, and a discharging bypass pipe that is connected with the fuel inflow pipe and the fuel outflow pipe via the other 3-way valve.

Yet another embodiment of the present invention provides a driving method o a fuel cell system that includes the steps of injecting fuel to a fuel outlet, discharging non-reacted fuel to a fuel inlet, and transferring the non-reacted discharged to the fuel inlet to the fuel outflow pipe.

The driving method of a fuel cell system according to an exemplary embodiment of the present invention may further include the step of removing impurities included in the non-reacted fuel discharged from the fuel cell stack.

The step of injecting the fuel into the fuel outlet may include the steps of connecting a supplying bypass pipe with a fuel inflow pipe and intercepting connection between the fuel inflow pipe and the fuel inlet.

The step of injecting the fuel to the fuel outlet may further include the steps of transferring the fuel to the supplying bypass pipe from the fuel inflow pipe, transferring the fuel to a fuel outflow pipe from the supplying bypass pipe, and injecting the fuel into the fuel outlet from the fuel outflow pipe.

The step of transferring the non-reacted fuel discharged to the fuel inlet to the fuel outflow pipe may include the steps of connecting the discharging bypass pipe with the fuel outflow pipe, and intercepting connection between the fuel outflow pipe and the fuel outlet.

The step of transferring the non-reacted fuel discharged to the fuel inlet to the fuel outflow pipe may further include the steps of transferring the fuel to the second bypass from the fuel inflow pipe and transferring the fuel to the fuel outflow pipe from the discharging bypass pipe.

Another aspect of the invention is a fuel cell system, comprising: a fuel supply unit; a fuel cell stack in fluid communication with the fuel supply unit, wherein the fuel cell stack has a fuel inlet and a fuel outlet; and a bypass pipe configured to transfer fuel received from the fuel supply unit to a fuel outflow pipe connected to the fuel outlet.

The above fuel cell system may further comprise a filter disposed in line with a fuel inflow pipe, wherein the fuel inflow pipe connects the fuel cell stack to the fuel supply unit. The fuel cell system may further comprise a supply valve disposed in line with a fuel inflow pipe, wherein the supply valve is configured to deliver the received fuel to the bypass pipe. In the above fuel cell system, the supply valve may be located between the fuel inlet and a filter. The above fuel cell system may further comprise another bypass pipe configured to transfer non-reacted fuel discharged from the fuel inlet to the fuel outflow pipe.

The above fuel cell system may further comprise a discharge valve disposed in line with the fuel outflow pipe, wherein the discharge valve is configured to deliver the non-reacted fuel to the other bypass pipe. The above fuel cell system may further comprise a discharge valve disposed between the fuel supply unit and fuel outlet. In the above fuel cell system, each of the supply valve and the discharge valve may be a three-way valve. In the above fuel cell system, the supply valve and the discharge valve may be electrically connected to a control unit.

Another aspect of the invention is a fuel cell system, comprising: a fuel supply unit; a fuel cell stack in fluid communication with the fuel supply unit, wherein the fuel cell stack has a fuel inlet and a fuel outlet; a supplying bypass pipe configured to transfer fuel received from the fuel supply unit to a fuel outflow pipe connected to the fuel outlet; a discharging bypass pipe configured to transfer non-reacted fuel discharged from the fuel inlet to the fuel outflow pipe; a supply valve configured to deliver the received fuel to the bypass pipe; and a discharge valve configured to deliver the non-reacted fuel to the other bypass pipe.

Another aspect of the invention is a method of driving a fuel cell system, the method comprising: receiving fuel from a fuel supply unit; transferring the received fuel to a fuel outflow pipe connected to a fuel outlet of a fuel cell stack; and discharging non-reacted fuel from a fuel inlet of the fuel cell stack.

The above method may further comprise transferring the non-reacted fuel discharged from the fuel inlet to a fuel outflow pipe. In the above method, the transferring of the non-reacted fuel may comprise: connecting a supplying bypass pipe with the fuel outflow pipe; and interrupting fluid communication between the fuel outflow pipe and the fuel outlet.

In the above method, the transferring of the non-reacted fuel may further comprise: transferring from the fuel inflow pipe the fuel to the supplying bypass pipe; and transferring the fuel from the supplying bypass pipe to the fuel outflow pipe. The above method may further comprise removing impurities included in the non-reacted fuel. In the above method, the removing may comprise passing fuel through a filter in the fuel inflow pipe. The above method may further comprise injecting the transferred fuel into the fuel outlet. In the above method, the injecting may comprise: connecting a fuel inflow pipe with the discharging bypass pipe; and interrupting fluid communication between the fuel inflow pipe and the fuel inlet.

### BRIEF DESCRIPTION OF THE DRAWINGS

An apparatus according to some of the described embodiments can have several aspects, no single one of which necessarily is solely responsible for the desirable attributes of the apparatus. After considering this discussion, and particularly after reading the section entitled “Detailed Description of Certain Inventive Embodiments” one will understand how the features of embodiments of this invention provide advantages that include the ability to make and use a fuel cell system and driving method thereof.

FIG. 1 is a schematic diagram of a fuel cell system according to a first exemplary embodiment of the present disclosure.

FIG. 2 is an exploded perspective view illustrating a structure of the fuel cell stack shown in FIG. 1.

FIG. 3 is a flowchart of a driving method of a fuel cell system according to an exemplary embodiment of the present disclosure.

FIG. 4A is a photograph illustrating a voltage table of a defective fuel cell stack.

FIG. 4B is a photograph illustrating a voltage table of a normal fuel cell stack.

### DETAILED DESCRIPTION OF CERTAIN INVENTIVE EMBODIMENTS

Embodiments of the present invention will be described more fully hereinafter with reference to the accompanying drawings, in which exemplary embodiments are shown. As those skilled in the art would realize, the described embodiments may be modified in various different ways, all without departing from the spirit or scope of the present invention.

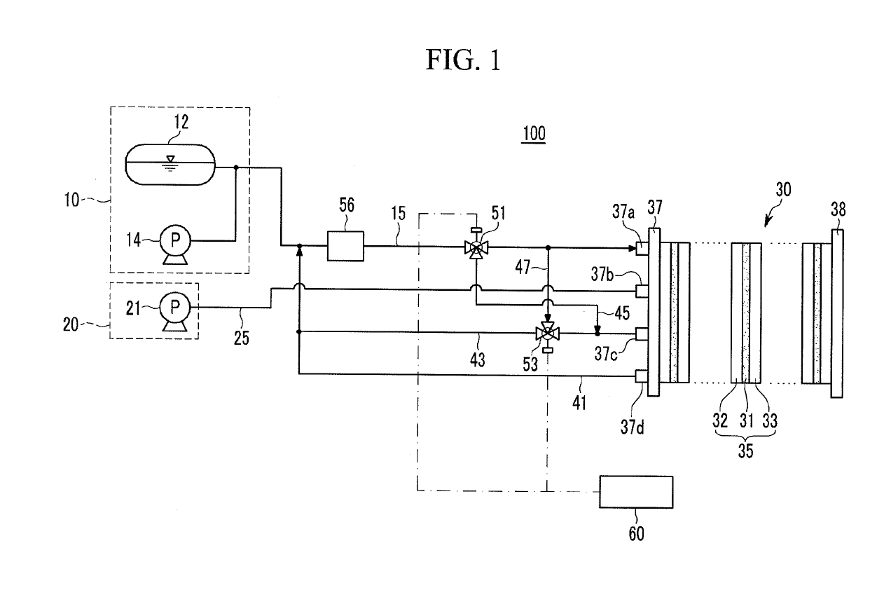

FIG. 1 is a schematic diagram illustrating an entire configuration of a fuel cell system according to a first exemplary embodiment of the present disclosure. The fuel cell system 100 may adopt a direct methanol fuel cell (“DMFC”) scheme, which generates electrical energy by direct reaction of methanol and oxygen.

However, the present disclosure is not limited thereto and the fuel cell system according to the exemplary embodiment may be configured by a direct oxidation fuel cell (“DOFC”) scheme, which reacts liquid or gas fuel containing hydrogen, such as ethanol, LPG, LNG, gasoline, butane gas, etc. with oxygen. Further, the fuel cell system may be configured by a polymer electrode fuel cell (“PEMFC”), which uses the fuel by reforming the fuel into reformed gas containing sufficient hydrogen. The fuel used in the fuel cell system 100 generally represents hydrocarbon-based fuel in a liquid or gas state, such as methanol, ethanol, natural gas, LPG, etc.

In addition, the fuel cell system 100 may use oxygen gas (stored in an additional storing means) or air as the oxidant that reacts with hydrogen.

The fuel cell system 100 includes a fuel cell stack 30, a fuel supply unit 10 and an oxidant supply unit 20. The fuel cell stack 30 is configured to generate power by reacting the fuel and the oxidant. The fuel supply unit is configured to supply the fuel to the fuel cell stack 30. The oxidant supply unit 20 is configured to supply the oxidant for generating electricity to the fuel cell stack 30. The fuel supply unit 10 is connected to the fuel cell stack 30. The fuel supply unit 10 includes a fuel tank 12 that stores liquefied fuel and a fuel pump 14 that is connected to the fuel tank 12. The fuel pump 14 serves to discharge the liquefied fuel stored in the fuel tank 12 from the inside of the fuel tank 12 by a predetermined pumping force. In some embodiments, the fuel stored in the fuel supply unit 10 may consist of high-concentration methanol. The oxidant supply unit 20 is connected with the fuel cell stack 30. The oxidant supply unit 20 includes an oxidant pump 21 that suctions external air and supplies the external air to the fuel cell stack 30 by the predetermined pumping force.

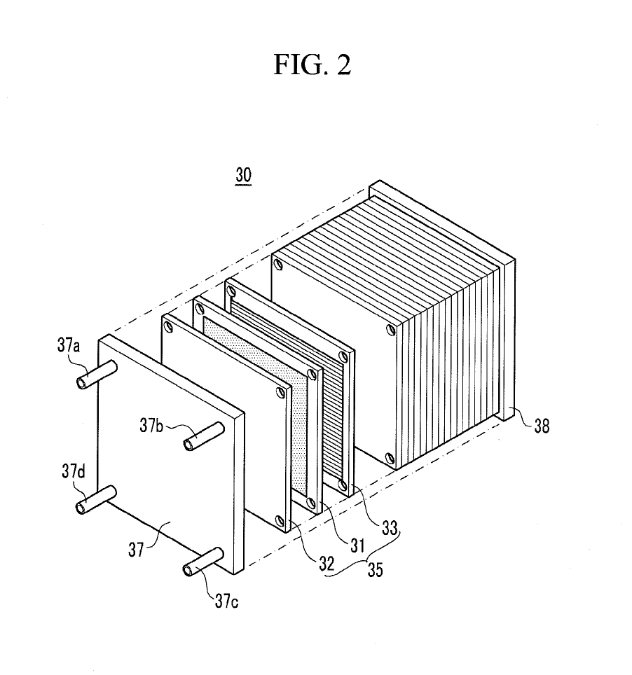

FIG. 2 is an exploded perspective view illustrating a structure of the fuel cell stack shown in FIG. 1. Referring to FIGS. 1 and 2, the fuel cell stack 30 adopted in the fuel cell system 100 includes a plurality of electricity generating units 35 that generates electrical energy by inducing oxidation and reduction reactions of the fuel and the oxidant. Each of the electricity generating unit 35 represents a unit cell that generates the electricity and includes a membrane electrode assembly (“MEA”) 31 that oxidizes and reduces oxygen in the fuel and the oxidant and separators (also referred to as a bipolar plate) 32 and 33 that supply the fuel and the oxidant to the membrane electrode assembly 31.

The electricity generating unit 35 has a structure in which the separators 32 and 33 are disposed at both sides around the membrane electrode assembly 31. The membrane electrode assembly 31 includes an electrolyte membrane disposed at the center thereof, a cathode electrode disposed at one side of the electrolyte membrane and an anode electrode disposed at the other side of the electrolyte membrane.

The separators 32 and 33 are in close proximity to each other with the MEA 31 interposed therebetween. The separators 32 and 33 each have a fuel passage and an oxidant passage at both sides of the MEA 31. The fuel passage is disposed at the anode electrode of the MEA 31 and the oxidant passage is disposed at the cathode electrode of the MEA 31. In addition, the electrolyte membrane enables ion exchange in which hydrogen ions generated from the anode electrode move to the cathode electrode and are bound to oxygen of the cathode electrode to generate water.

In the fuel cell system 100, the plurality of electricity generating units 35 are successively arranged to constitute the fuel cell stack 30. End plates 37 and 38 are installed in outermost parts of the fuel cell stack 30. The end plates 37 and 38 may be configured for integrally fixing the fuel cell stack 30.

A fuel inlet 37a may be configured for injecting the fuel to the fuel cell stack 30 and an oxidant inlet 37b may be configured for injecting the oxidant to the stack are formed in end plate 37. A fuel outlet 37c may be configured for discharging non-reacted fuel remaining after reaction at the anode electrode and an oxidant outlet 37d may be configured for discharging moisture and non-reacted air generated by a bonding reaction of hydrogen and oxygen at the cathode electrode are formed in the end plate 37.

End plate 38 is configured to pressurize the electricity generating units 35 with facing the one end plate 37. Although the inlets 37a and 37b and the outlets 37c and 37d are formed only in the one end plate 37, the present invention is not limited thereto. In another embodiment the inlets 37a and 37b may be formed in the end plate 37 and the outlets 37c and 37d may be formed in the end plate 38. In other embodiments one or more of the inlets 37a, 37b, 37c and 37d may be formed in at least one of the end plate 37 and the end plate 38.

As shown in FIG. 1, the fuel supply unit 10 is connected with the fuel inlet 37a through a fuel inflow pipe 15 and the oxidant supply unit 20 is connected with the oxidant inlet 37b through an oxidant supply pipe 25. A fuel outflow pipe 43 is connected to the fuel outlet 37c and an oxidant outflow pipe 41 is connected to the oxidant outlet 37d.

In some embodiments the fuel outflow pipe 43 and the oxidant outflow pipe 41 may be connected with a fuel inflow pipe 15 in order to recover non-reacted fuel and moisture. A filter 56 is installed in the fuel inflow pipe 15. The filter 56 can be configured to remove impurities included in the fuel which is supplied to the fuel cell stack.

Meanwhile, a supplying bypass pipe 45 is installed between the fuel inflow pipe 15 and the fuel outflow pipe 43. The supplying bypass pipe 45 may be configured to transfer the fuel transferred from the fuel supply unit 10 to the fuel outflow pipe 43. Further, a discharging bypass pipe 47 is installed between the fuel inflow pipe 15 and the fuel outflow pipe 43. The discharging bypass pipe 47 may be configured to transfer the fuel transferred from the non-reacted fuel discharged from the fuel inlet 37a to the fuel outflow pipe 43.

In the fuel inflow pipe 15, the supplying bypass pipe 45 is installed closer to the fuel supply unit 10 than the discharging bypass pipe 47 and the discharging bypass pipe 47 is installed closer to the fuel cell stack 30 than the supplying bypass pipe 45. In the fuel outflow pipe 43, the supplying bypass pipe 45 is installed closer to the fuel cell stack 30 than the discharging bypass pipe 47. As a result, the supplying bypass pipe 45 and the discharging bypass pipe 47 are not in fluid communication with each other, but cross each other.

The supplying bypass pipe 45 is in fluid communication with the fuel inflow pipe 15 through a supply valve 51. The discharging bypass pipe 47 is in fluid communication with the fuel outflow pipe 43 through a discharge valve 53. In the embodiment of FIG. 1, the supply valve 51 and the discharge valve 53 each comprise a 3-way valve.

The fuel cell system 100 further includes a control unit 60. When the fuel cell system 100 is defective in operation, the control unit 60 controls the supply valve 51 to allow the fuel supply unit 10 and the supplying bypass pipe 45 to be in fluid communication with each other via the fuel inflow pipe 15. Thus, the fluid from the fuel supply unit 10 is passed through the fuel inflow pipe 15 and diverted by the supply valve 51 to the supplying bypass pipe 45 so that the fuel may be injected into the fuel outlet 37c. In other words, the supply valve 51 interrupts fluid communication between the fuel inflow pipe 15 and the fuel cell stack 30 to allow the fuel that is injected from the fuel supply unit 10 to flow through the supplying bypass pipe 45.

Further, the control unit 60 may be configured to control the discharge valve 53 to allow the discharging bypass pipe 47 and the fuel outflow pipe 43 to be in fluid communication with each other so as to discharge the non-reacted fuel discharged from the fuel inlet 37a to the fuel outflow pipe 43. Thus, the discharge valve 53 interrupts fluid communication between the fuel outflow pipe 43 and the fuel cell stack 30, such that the non-reacted fuel is not injected into the fuel cell stack 30, but instead may be discharged. An operation in which the fuel is injected into the fuel outlet 37c and the fuel is discharged to the fuel inlet 37a is a “reverse operation”. An operation in which the fuel is injected into the fuel inlet 37a and the fuel is discharged from the fuel outlet 37c is a “forward operation”.

In operation the non-reacted fuel passes through the fuel outflow pipe 43 then into the fuel inflow pipe 15, wherein the non-reacted fuel passes through the filter 56. Impurities included in the non-reacted fuel then may be filtered by the filter 56. The filter 56 may be periodically replaced so that impurities may be easily removed.

After the reverse operation is performed for a predetermined time, the control unit 60 interrupts the fluid communication between the fuel inflow pipe 15 and the supplying bypass pipe 45 and interrupts the fluid communication between the fuel outflow pipe 43 and the discharging bypass pipe 47. In addition, the fuel inflow pipe 15 and the fuel inlet 37a are in fluid communication with each other and the fuel outflow pipe 43 and the fuel outlet 37c are in fluid communication with each other.

As a result, the fuel is again supplied to the fuel inlet 37a through the fuel inflow pipe 15 and the fuel outlet 37c and the fuel outflow pipe 43 are in fluid communication with each other to discharge the non-reacted fuel.

Like the exemplary embodiment, when the supplying bypass pipe 45 and the discharging bypass pipe 47 are connected to the supply valve 51 and the discharge valve 53, respectively, low-concentration fuel is in contact with a part where high-concentration fuel flows and the high-concentration fuel is in contact with a part where the low-concentration fuel flows. As a result, the fuel cell stack 30 is reactivated, such that the durability and lifespan of the fuel cell stack are improved. Further, the impurities accumulated in the fuel cell stack 30 may be discharged to the outside by reversely injecting the fuel.

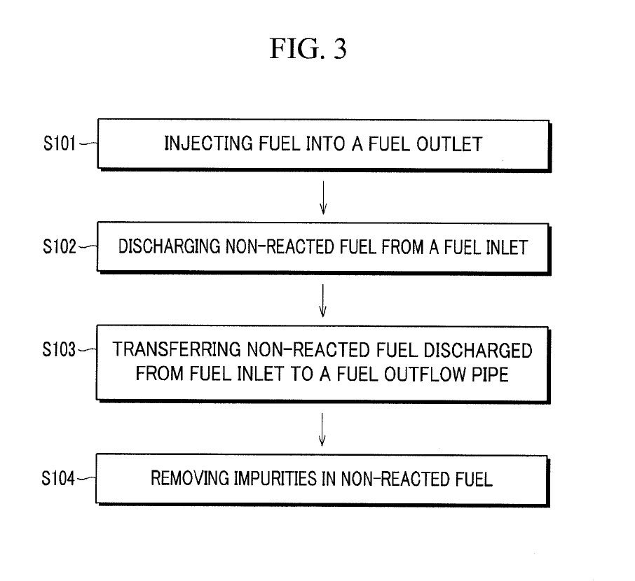

FIG. 3 is a flowchart of a driving method of a fuel cell system according to an exemplary embodiment of the present disclosure. Referring to FIG. 3, the driving method of the fuel cell system 100 includes the steps of injecting fuel into a fuel outlet 37c (S101), discharging non-reacted fuel to a fuel inlet 37a (S102), transferring the non-reacted fuel discharged to the fuel inlet 37a to a fuel outlet pipe 43 (S103), and removing impurities included in the non-reacted fuel (S104).

The step of injecting the fuel into the fuel outlet 37c (S101) includes the steps of connecting a bypass pipe 45 with a fuel inflow pipe 15 and intercepting connection between the fuel inflow pipe 15 and the fuel inlet 37a.

The fuel inflow pipe 15 and the supplying bypass pipe 45 are connected to each other by a supply valve 51. Fluid communication between the fuel inflow pipe 15 and the fuel inlet 37a may be interrupted by the supply valve 51. That is, the supply valve 51 is configured to close a pipe connecting the fuel inflow pipe 15 and the fuel inlet 37a and the supply valve 51 is configured to open a part connected with the supplying bypass pipe 45.

By the above-mentioned supply valve 51, the fuel may be injected into the supplying bypass pipe 45 through the fuel inflow pipe 15. Further, the fuel injected into the supplying bypass pipe 45 may be injected into the fuel outlet 37c through the fuel outflow pipe 43. Therefore, the step of injecting the fuel into the fuel outlet 37c (S101) illustrated in FIG. 3 further includes transferring the fuel from the fuel inflow pipe 15 to the supplying bypass pipe 45, transferring the fuel from the supplying bypass pipe 45 to the fuel outflow pipe 43, and injecting the fuel from the fuel outflow pipe 43 to the fuel outlet 37c.

As described above, the fuel transferred to the fuel inflow pipe 15 from a fuel supply unit 10 is injected into the fuel outlet 37c by passing through the supplying bypass pipe 45 and the fuel outflow pipe 43 in sequence. The fuel injected into the fuel outlet 37c reacts with oxidant in a fuel cell stack 30 and the non-reacted fuel is discharged to the fuel inlet 37a.

The step of transferring the non-reacted fuel discharged to the fuel inlet 37a to the fuel outflow pipe 43 (S103) illustrated in FIG. 3 includes the steps of fluidly connecting a discharging bypass pipe 47 with the fuel outflow pipe 43 and interrupting fluid communication between the fuel outflow pipe 43 and the fuel outlet 37c.

The fuel outflow pipe 43 and the discharging bypass pipe 47 may be in fluid communication with each other by a discharge valve 53. The fuel outflow pipe 43 and the fuel outlet 37c also may be in fluid communication with each other by the discharge valve 53. That is, the discharge valve 53 is configured to close a connection with the fuel outflow pipe 43 and the fuel outlet 37c and simultaneously open a connection with the discharging bypass pipe 47.

By the above-mentioned discharge valve 53, the fuel discharged from the fuel inlet 37a is injected into the discharging bypass pipe 47 through the fuel inflow pipe 15. Further, the fuel injected into the discharging bypass pipe 47 may be discharged through the fuel outflow pipe 43. Therefore, the step of transferring the non-reacted fuel discharged from the fuel inlet 37a to the fuel outflow pipe 43 (S103) illustrated in FIG. 3 further includes the steps of transferring the fuel from the fuel inflow pipe 15 to the discharging bypass pipe 47 and transferring the fuel from the discharging bypass pipe 47 to the fuel outflow pipe 43.

As described above, the fuel transferred to the fuel inflow pipe 15 from the fuel inlet 37a may be discharged by passing through the discharging bypass pipe 47 and the fuel outflow pipe 43 in sequence. When the fuel is injected into the fuel outlet 37c and the fuel is discharged to the fuel inlet 37a, a “reverse operation” is performed, thereby removing impurities. The impurities included in the fuel are filtered by the filter 56, and the impurities created in the fuel cell stack 30 are expelled by the flow pressure. However, when the impurities created in the fuel cell stack 30 block the inlet of passage under certain conditions, the fuel may not flow into the electricity generating unit 35. In such a situation, if the inlet and outlet are exchanged and the fuel flows in the reverse direction, the impurities located at the inlet of passage may be expelled to the fuel outflow pipe 43. Impurities transferred to the fuel inlet pipe 15 and then filtered at the filter 56 are thereafter not able to flow back into the fuel cell stack 30. Therefore, if the filter 56 is changed periodically the fuel cell stack 30 may be used much longer than a conventional fuel cell stack.

When the fuel flows in a reverse direction during the reverse operation, low-concentration fuel may contact high-concentration fuel flow and the high-concentration fuel may contact low-concentration fuel flow. This condition may act to “reactivate” the fuel cell stack 30 and improve durability and/or lifespan of the fuel cell stack 30.

In the step of removing the impurities included in the non-reacted fuel (S104) as illustrated in FIG. 3, the impurities are removed by using a filter 56 installed in the fuel inflow pipe 15 during a process of inflow back to the fuel cell stack 30. The impurities may be present, for example, in the non-reacted fuel discharged to the fuel inlet 37a. The impurities are filtered by the filter 56 in fluid communication with the fuel outflow pipe 43 via the fluid inflow pipe 15.

Meanwhile, the driving method of the fuel cell system 100 may further includes the steps of injecting the fuel into the fuel inflow pipe 15 and the fuel inlet 37a and discharging the non-reacted fuel to the fuel outlet 37c and the fuel outflow pipe 43. Through these steps, the fuel is supplied in a forward direction. After the reverse operation described above is continuously performed for a predetermined time, the forward operation is also performed.

When an error occurs in the fuel cell stack 30, the reverse operation is performed. In addition, in order to improve the durability, the reverse operation described above may be periodically performed for the predetermined time even when the fuel cell stack 30 has no error.

A control unit 60 monitors a voltage of each of an electricity generating units 35. When a voltage of a predetermined electricity generating unit 35 decreases to a reference voltage or less, the control unit 60 can control the supply valve 51 and the discharge valve 53 so as to supply the fuel in the reverse direction.

When the voltage of each electricity generating unit 35 is recovered to a normal voltage by supplying the fuel in the reverse direction, the control unit 60 controls the supply valve 51 and the discharge valve 53 so as to supply the fuel in the forward direction again.

Further, by setting a time for which the fuel is supplied in the forward direction and a time for which the fuel is supplied in the reverse direction to the same value, the forward operation and the reverse operation may be alternately performed.

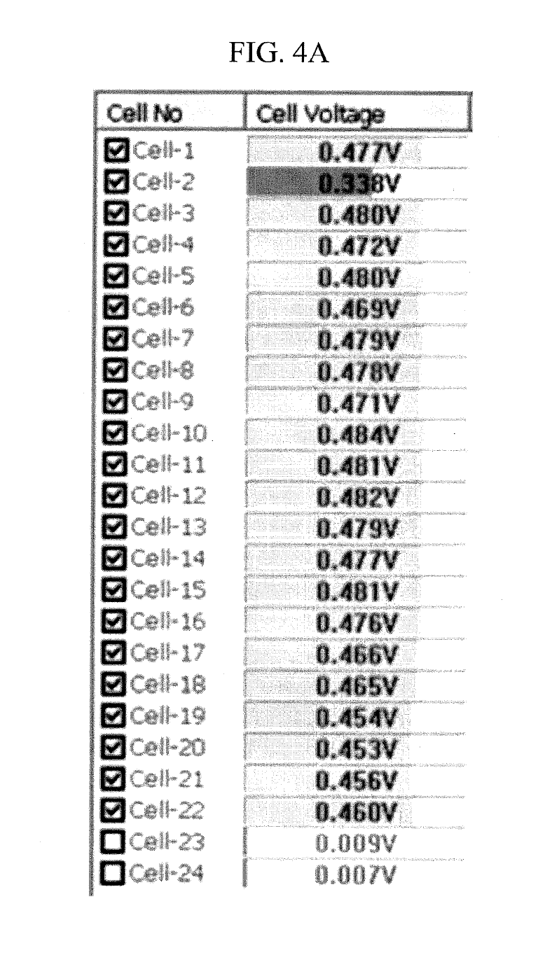

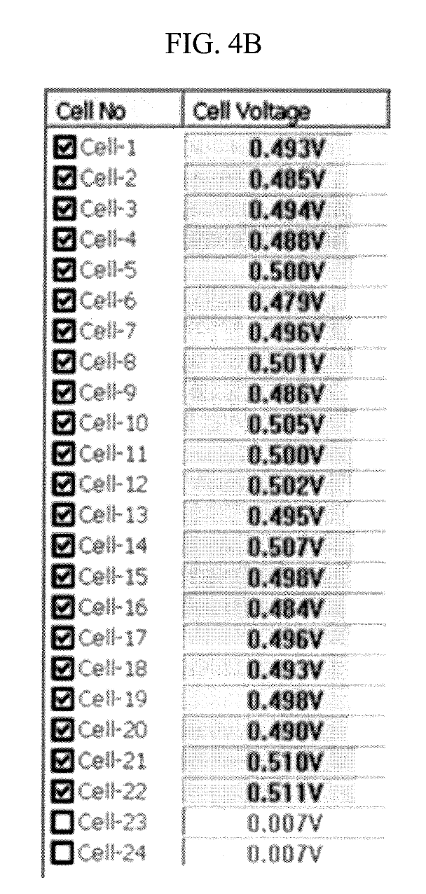

FIG. 4A is a photograph illustrating a voltage of a defective fuel cell stack. FIG. 4B is a photograph illustrating a voltage of a normal fuel cell stack. Referring to FIGS. 4A and 4B, in this experiment, a direct methanol fuel cell having a current of approximately 1.72 A and an output of approximately 17.5 W is used.

As shown in FIG. 4A, a second electricity generating unit is defective, such that a voltage decreases to 0.338V. One reason why the voltage decreases is that a fuel passage may be blocked, such that the fuel is not supplied normally. In FIG. 4B, the problem may be solved by supplying the fuel in the reverse direction by the driving method of the fuel cell system described above.

As shown in FIG. 4B, impurities remaining in the fuel passage are removed, such that the voltage of the second electricity generating unit is recovered to 0.485V. As such, when the error occurs in the fuel cell, it is possible to very easily solve the problem without disassembling the fuel cell stack.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A fuel cell system, comprising:
a fuel supply unit;
a fuel cell stack in fluid communication with the fuel supply unit, wherein the fuel cell stack has a fuel inlet and a fuel outlet; and
a bypass pipe configured to transfer fuel received from the fuel supply unit to a fuel outflow pipe connected to the fuel outlet.

2. The fuel cell system of claim 1, further comprising a filter disposed in line with a fuel inflow pipe, wherein the fuel inflow pipe connects the fuel cell stack to the fuel supply unit.

3. The fuel cell system of claim 1, further comprising a supply valve disposed in line with a fuel inflow pipe, wherein the supply valve is configured to deliver the received fuel to the bypass pipe.

4. The fuel cell system of claim 3, wherein the supply valve is located between the fuel inlet and a filter.

5. The fuel cell system of claim 3, further comprising another bypass pipe configured to transfer non-reacted fuel discharged from the fuel inlet to the fuel outflow pipe.

6. The fuel cell system of claim 5, further comprising a discharge valve disposed in line with the fuel outflow pipe, wherein the discharge valve is configured to deliver the non-reacted fuel to the other bypass pipe.

7. The fuel cell system of claim 5, further comprising a discharge valve disposed between the fuel supply unit and fuel outlet.

8. The fuel cell system of claim 7, wherein each of the supply valve and the discharge valve is a three-way valve.

9. The fuel cell system of claim 7, wherein the supply valve and the discharge valve are electrically connected to a control unit.

10. A fuel cell system, comprising:
a fuel supply unit;
a fuel cell stack in fluid communication with the fuel supply unit, wherein the fuel cell stack has a fuel inlet and a fuel outlet;
a supplying bypass pipe configured to transfer fuel received from the fuel supply unit to a fuel outflow pipe connected to the fuel outlet;
a discharging bypass pipe configured to transfer non-reacted fuel discharged from the fuel inlet to the fuel outflow pipe;
a supply valve configured to deliver the received fuel to the bypass pipe; and
a discharge valve configured to deliver the non-reacted fuel to the other bypass pipe.

11. A method of driving a fuel cell system, the method comprising:
receiving fuel from a fuel supply unit;
transferring the received fuel to a fuel outflow pipe connected to a fuel outlet of a fuel cell stack; and
discharging non-reacted fuel from a fuel inlet of the fuel cell stack.

12. The method of claim 11, further comprising transferring the non-reacted fuel discharged from the fuel inlet to a fuel outflow pipe.

13. The method of claim 12, wherein the transferring of the non-reacted fuel comprises:
connecting a supplying bypass pipe with the fuel outflow pipe; and
interrupting fluid communication between the fuel outflow pipe and the fuel outlet.

14. The method of claim 13, wherein the transferring of the non-reacted fuel further comprises:
transferring from the fuel inflow pipe the fuel to the supplying bypass pipe; and
transferring the fuel from the supplying bypass pipe to the fuel outflow pipe.

15. The method of claim 11, further comprising removing impurities included in the non-reacted fuel.

16. The method of claim 15, wherein the removing comprises passing fuel through a filter in the fuel inflow pipe.

17. The method of claim 11, further comprising injecting the transferred fuel into the fuel outlet.

18. The method of claim 17, wherein the injecting comprises:
connecting a fuel inflow pipe with the discharging bypass pipe; and
interrupting fluid communication between the fuel inflow pipe and the fuel inlet.
